(19) United States
(12) Patent Application Publication
(10) Pub. No.: US 2014/0127113 A1
(43) Pub. Date: May 8, 2014

(54) PROCESS FOR PRODUCING SCALY SILICA PARTICLES

(71) Applicant: AGC Si-Tech Co., Ltd., Kitakyushu-shi (JP)

(72) Inventors: Takayoshi SASAKI, Kitakyushu-shi (JP); Ikuyo NOMURA, Kitakyushu-shi (JP); Shinnosuke ARIMITSU, Kitakyushu-shi (JP); Hiroyoshi MIYAHARA, Kitakyushu-shi (JP)

(73) Assignee: AGC Si-Tech Co., Ltd., Kitakyushu-shi (JP)

(21) Appl. No.: 14/062,266

(22) Filed: Oct. 24, 2013

(30) Foreign Application Priority Data
Nov. 8, 2012 (JP) 2012-245991

(51) Int. Cl. C01B 33/12

(52) U.S. Cl. CPC C01B 33/126
USPC 423/335

(57) ABSTRACT

To produce scaly silica particles in which formation of irregular particles is prevented.

A process for producing scaly silica particles, which comprises a step of subjecting a silica powder containing silica agglomerates having scaly silica particles agglomerated, to acid treatment at a pH of at most 2, a step of subjecting the silica powder subjected to the acid treatment, to alkali treatment at a pH of at least 8 to deflocculate the silica agglomerates, and a step of wet disintegrating the silica powder subjected to the alkali treatment to obtain scaly silica particles.

### BACKGROUND OF INVENTION

1. Field of Invention

The present invention relates to a process for producing scaly silica particles, and scaly silica particles.

2. Discussion of Background

Scaly silica particles have a self film-forming property, and are capable of forming a strong silica coating film even at room temperature. A silica coating film formed by scaly silica particles is particularly excellent in the acid resistance, the alkali resistance and the heat resistance.

Patent Document 1 discloses, as a process for producing scaly silica particles having predetermined physical properties, a process for producing scaly silica particles comprising secondary particles, which comprises subjecting a silica hydrogel or a silica sol to hydrothermal treatment in the presence of an alkali metal salt to form scaly silica tertiary agglomerated particles, and disintegrating and dispersing the scaly silica tertiary agglomerated particles by a wet disintegrator or a dry pulverizing/classifying machine.

As proposed in Patent Document 1, the scaly silica tertiary agglomerated particles are formed by agglomeration of secondary particles, and they can be formed into smaller particles to a certain extent by disintegrating and dispersing them by a wet disintegrator or a dry pulverizing/classifying machine. If large particles such as irregular particles are included in the obtained scaly silica particles, such large particles may decrease the denseness of the obtainable silica coating film and thus the strength. Accordingly, in the process for producing scaly silica particles, it is desired to make the scaly silica tertiary agglomerated particles be formed into further smaller particles and to prevent formation of large particles.

On the other hand, Non-Patent Document 1 discloses to disperse agglomerates of synthesized magadiite or kenyaite into a small plate form by treating it with a solution of KOH, LiOH or NH₄OH. In Non-Patent Document 1, agglomerates having diameters of from 5 to 20 μm are dispersed into a small plate form with a maximum particles size of 4 μm (FIGS. 1 and 3).

As described above, a powder after dispersion in Non-Patent Document 1 contains large particles. However, scaly silica particles are required to have a smaller particles size, and formation into further smaller particles is desired. Further, in formation into smaller particles, it is desired that the particles are totally formed into smaller particles, and that large particles such as irregular particles are not included.

Further, as the scaly silica particles, in addition to magadiite and kenyaite in Non-Patent Document 1, scaly silica particles having a silica-X or silica-Y crystal structure are suitably for a hardenable composition. It is desired to form scaly silica particles having such a crystal structure into smaller particles.

### PRIOR ART DOCUMENTS

### Patent Documents

Patent Document 1: Japanese Patent No. 4063464

### Non-Patent Document

Non-Patent Document 1: Kosuge et al., Langmuir 1996, 12, p 1124-1126

### SUMMARY OF INVENTION

It is an object of the present invention to provide scaly silica particles in which formation of irregular particles is prevented.

The present invention provides a process for producing scaly silica particles, which comprises a step of subjecting a silica powder containing silica agglomerates having scaly silica particles agglomerated, to acid treatment at a pH of at most 2, a step of subjecting the silica powder subjected to the acid treatment, to alkali treatment at a pH of at least 8 to deflocculate the silica agglomerates, and a step of wet disintegrating the silica powder subjected to the alkali treatment to obtain scaly silica particles.

The present invention further provides scaly silica particles produced by the process for producing scaly silica particles.

According to the present invention, it is possible to provide scaly silica particles in which formation of irregular particles is prevented.

### BRIEF DESCRIPTION OF DRAWINGS

FIG. 1 is a transmission electron micrograph of silica agglomerates contained in a silica dispersion in Example 1.

FIG. 2 is a transmission electron micrograph of silica particles after alkali treatment of a silica dispersion in Example 1.

FIG. 3 is a transmission electron micrograph of silica particles after wet disintegration of a silica dispersion in Example 1.

FIG. 4 is a transmission electron micrograph of silica particles after wet disintegration of a silica dispersion in Example 2.

FIG. 5 is a transmission electron micrograph of silica particles after wet disintegration of a silica dispersion in Example 3.

FIG. 6 is a transmission electron micrograph of silica particles after wet disintegration of a silica dispersion in Comparative Example 1.

FIG. 7 is a graph illustrating zeta potentials in Examples 1 to 3.

### DETAILED DESCRIPTION OF PREFERRED EMBODIMENTS

Now, embodiments of the present invention will be described. However, the present invention is by no means restricted to such specific embodiments.

The process for producing scaly silica particles according to an embodiment of the present invention comprises a step of subjecting a silica powder containing silica agglomerates having scaly silica particles agglomerated, to acid treatment at a pH of at most 2, a step of subjecting the silica powder subjected to the acid treatment, to alkali treatment at a pH of at least 8 to deflocculate the silica agglomerates, and a step of wet disintegrating the silica powder subjected to the alkali treatment to obtain scaly silica particles.

According to such a production process, it is possible to provide scaly silica particles in which formation of irregular particles is prevented. By producing a hardenable composition or the like using such scaly silica particles, a coating film in which scaly silica particles are densely packed can be formed, whereby the coating film strength can be increased.

Here, the scaly silica particles are composed of flaky silica primary particles and/or scaly silica secondary particles each formed by a parallel face-to-face alignment of a plurality of flaky silica primary particles which are overlaid one on another. The scaly silica secondary particles usually have a particle form of a laminated structure. Further, each of the flaky silica primary particles and the scaly silica secondary particles may constitute scaly silica particles by themselves or in combination.

Further, the silica agglomerates having the scaly silica particles agglomerated are silica tertiary particles in the form of porous disorderly agglomerates of scaly silica particles.

Further, the irregular particles are particles such that the silica agglomerates are disintegrated to a certain extent, however, they are not disintegrated to respective scaly silica particles, and a plurality of scaly silica particles form an agglomerate.

As the silica agglomerates having the scaly silica particles agglomerated, so-called layered polysilicic acid and/or its salt may be used. Here, the layered polysilicic acid is polysilicic acid having a silicate layer structure having SiO₂ tetrahedrons as the primary structural units. The layered polysilicic acid and/or its salt may, for example, be silica-X (SiO₂—X), silica-Y (SiO₂—Y), kenyaite, magadiite, makatite, ilerite, kanemite or octosilicate. Among them, silica-X and silica-Y are preferred.

Each of silica-X and silica-Y is an intermediate or metastable phase formed in the process of subjecting silica materials to hydrothermal treatment to form cristobalite or quartz, and is a weak crystalline phase which may be considered as quasicrystalline substance of silica.

Here, silica-X and silica-Y are different in X-ray diffraction pattern, but they are very similar to each other in the particle outer appearance as observed by an electron microscope, and both can be preferably used to obtain the scaly silica particles.

The X-ray diffraction spectra of silica-X and silica-Y indicate that silica-X is characterized by the main peaks at 2θ=4.9°, 26.0° and 28.3° corresponding to ASTM (American Society for Testing and Materials) card (hereinafter referred to simply as ASTM card) number 16-0380 registered in the USA, and silica-Y is characterized by the main peaks at 2θ=5.6°, 25.8° and 28.3°, corresponding to ASTM card number 31-1233. The X-ray diffraction spectrum of the silica agglomerates is preferably characterized by such main peaks of silica-X and/or silica-Y.

### [Formation of Silica Powder]

As an example of the method of forming the silica powder, at least one of a silica hydrogel, a silica sol and hydrous silicic acid is subjected to hydrothermal treatment in the presence of an alkali metal salt to form a silica powder containing agglomerates having scaly silica particles agglomerated. The silica powder is not limited to one produced by this method and may be formed by any method.

(a) In a case where a silica hydrogel is used as the starting material, silica-X, silica-Y or the like as the silica agglomerates can be produced in a high yield at a low temperature in a short time without formation of crystals such as quartz. The silica hydrogel is preferably silica hydrogel particles, and they may be spherical or have irregular shapes and may be formed by an appropriately selected granulation method.

For example, spherical silica hydrogel may be formed by solidifying silica hydrosol into a spherical shape in a medium such as a petroleum solvent, but it is preferably formed by ejecting a sol formed by mixing an aqueous alkali metal silicate solution and an aqueous mineral acid solution into a medium gas so that a silica sol is formed in a short time simultaneously with the conversion of the sol into a gel in the gas. The aqueous mineral acid solution may, for example, be an aqueous sulfuric acid solution, hydrochloric acid or nitric acid.

That is, an aqueous alkali metal silicate solution and an aqueous mineral acid solution are introduced into a container equipped with a nozzle from different inlets and uniformly mixed instantaneously to form a silica sol having a pH of from 7 to 9 and a concentration of at least 130 g/L as calculated as SiO₂, and the silica sol is ejected from the nozzle into the medium gas such as air and is converted into a gel while it is flying. The falling gel particles are let to dive into an aging tank containing water placed at their landing site and are aged for from a few minutes to a few tens minutes. After addition of an acid and washing with water, a spherical silica hydrogel is obtained.

The silica hydrogel is transparent spherical particles having a uniform particle size with an average particle size of from about 2 to 10 mm and elasticity and contains, for example, about 4 times as much water as the weight of SiO₂ in some cases, and the SiO₂ concentration in the silica hydrogel is preferably from 15 to 75 mass %.

(b) In a case where the starting material is a silica sol, it is preferred to use a silica sol containing silica and an alkali metal in predescribed amounts. As the silica sol, it is preferred to use a silica sol obtained by dealkalizing an aqueous alkali metal silicate solution having a silica/alkali metal molar ratio (SiO₂/Me₂O, wherein Me is an alkali metal such as Li, Na or K; the same applies hereinafter) of from 1.0 to 3.4 by ion exchange with a resin or by electrodialysis. A preferable aqueous alkali metal silicate solution may be obtained, for example, by diluting water glass (aqueous sodium silicate solution) with a suitable amount of water.

The silica/alkali metal molar ratio (SiO₂/Me₂O) of the silica sol is preferably within a range of from 3.5 to 20, more preferably within a range of from 4.5 to 18. Further, the SiO₂ concentration in the silica sol is preferably from 2 to 20 mass %, more preferably from 3 to 15 mass %.

The average particle size of the silica in the silica sol is preferably from 1 to 100 nm. If the average particles size exceeds 100 nm, the stability of the silica sol tends to deteriorate. The silica sol is particularly preferably so-called active silicic acid having an average particles size of from 1 to 20 nm.

(c) In a case where hydrous silicic acid is used as the starting material, a silica powder containing silica agglomerates can be formed by the same method as in the case of the silica sol.

(d) Then, a silica source comprising the silica hydrogel, the silica sol, the hydrous silicic acid or a combination thereof is subjected to hydrothermal treatment in a heating pressure vessel such as an autoclave under heating in the presence of an alkali metal salt to form a silica powder containing silica agglomerates.

Any type of autoclave may be used without special restrictions as long as it is equipped at least with a heating means and a stirring means, and preferably equipped further with a thermometric means.

Further, prior to feeding the silica source into an autoclave for the hydrothermal treatment, purified water such as deionized water or distilled water may be added to adjust the silica concentration within a desired range.

In a case where the spherical silica hydrogel is used, it may be used as it is, or may be pulverized or roughly pulverized into a particle size of from about 0.1 to 6 mm.

The total silica concentration of the charged liquid in the autoclave is usually preferably from 1 to 30 mass %, more preferably from 10 to 20 mass % as calculated as SiO₂ based on the total amount of the charged starting materials, though its choice depends on the stirring efficiency, the crystal growth rate, the yield, etc. The total silica concentration of the charged liquid means the total silica concentration in the system and includes, not only silica in the form of the silica source, but also silica brought in the system in the form of sodium silicate or the like used as an alkali metal salt.

The conversion of the silica hydrogel to silica-X and/or silica-Y by the hydrothermal treatment may be promoted by incorporation of an alkali metal salt to the silica source because a pH shift of the charged liquid towards the alkaline side increases the solubility of silica moderately to allow faster precipitation attributable to the so-called Ostwald ripening.

Here, the alkali metal salt may be an alkali metal hydroxide, an alkali metal silicate, an alkali metal carbonate or a combination thereof. The alkali metal may be Li, Na, K or the like, or a combination thereof. The pH of the system is preferably at least 7, more preferably from 8 to 13, further preferably from 9 to 12.5.

The amount of the alkali metal to the total amount of the alkali metal and the silica, in terms of the silica/alkali metal molar ratio (SiO₂/Me₂O), is preferably within a range of from 4 to 15, more preferably within a range of from 7 to 13.

The hydrothermal treatment of the silica sol and the hydrous silicic acid is carried out preferably at a temperature of from 150 to 250° C., more preferably from 170 to 220° C., so as to increase the reaction rate and to suppress progress of crystallization. Further, the time for the hydrothermal treatment of the silica hydrosol and the hydrous silicic acid varies depending upon the temperature of the hydrothermal treatment or presence or absence of seed crystals, but usually, it is preferably from 3 o 50 hours, more preferably from 3 to 40 hours, further preferably from 5 to 25 hours.

The hydrothermal treatment of the silica hydrogel is carried out within a temperature range of preferably from 150 to 220° C., more preferably from 160 to 200° C., further preferably from 170 to 195° C. Further, the time required for the hydrothermal treatment varies depending upon the temperature of the hydrothermal treatment of the silica hydrogel or presence or absence of seed crystals, but usually, it is preferably from 3 to 50 hours, more preferably from 5 to 40 hours, further preferably from about 5 to 25 hours, especially preferably from about 5 to 12 hours.

Though it is not essential, addition of seed crystals in an amount of from about 0.001 to 1 mass %, based on the amount of the silica source charged is preferred to carry out the hydrothermal treatment efficiently and to shorten the treating time. As the seed crystal, silica-X, silica-Y or the like may be used as it is or after pulverization as the case requires.

After completion of the hydrothermal treatment, the product may be taken out from the autoclave, filtered and washed with water. The particles after washed with water preferably have a pH of from 5 to 9, more preferably from 6 to 8, in the form of a 10 mass % water slurry.

### [Silica Powder]

The above-formed silica powder contains silica agglomerates having scaly silica particles agglomerated. The silica agglomerates are silica tertiary particles in the form of porous disorderly agglomerates of scaly silica particles which are overlaid one on another. This can be confirmed by observing the above-formed powder by a scanning electron microscope (hereinafter sometimes referred to as “SEM”).

Here, flaky silica primary particles cannot be identified with a SEM, and scaly silica secondary particles each formed by a parallel face-to-face alignment of a plurality of silica primary particles which are overlaid one on another, can be identified.

In contrast, flaky silica primary particles thin enough to transmit electron rays partially can be identified with a transmission electron microscope (hereinafter sometimes referred to as “TEM”). Further, silica secondary particles each formed by a parallel face-to-face alignment of a plurality of silica primary particles which are overlaid one on another, can be identified. These silica primary particles and silica secondary particles constitute the scaly silica particles.

It is considered to be difficult to peel and isolate the flaky silica primary particles as constituting units one by one from the scaly silica secondary particles. That is, in the layered overlaid structure, the layers of the flaky silica primary particles are integrated by the firm interlayer bonding. Thus, it is considered to be difficult to disintegrate the scaly silica secondary particles into silica primary particles. By the process according to this embodiment, it is possible to disintegrate the silica agglomerates into the scaly silica secondary particles and further to disintegrate them into flaky silica primary particles.

The average particle size of the above-formed silica powder is preferably from 7 to 25 μm, more preferably from 7 to 11 μm.

### [Acid Treatment]

The process according to this embodiment comprises a step of subjecting the silica powder containing silica agglomerates having scaly silica particles agglomerated to acid treatment at a pH of at most 2, whereby deflocculation of the silica agglomerates by the subsequent alkali treatment can be promoted, and formation of irregular particles after the wet disintegrating step can be prevented.

Further, by the acid treatment, the alkali metal salt contained in the silica powder can be removed. In a case where the silica powder is formed by the hydrothermal treatment, an alkali metal salt added in the hydrothermal treatment can be removed.

The pH at the time of the acid treatment is at most 2, preferably at most 1.9. By the preliminary acid treatment with a low pH, the silica agglomerates are more likely to be deflocculated and disintegrated in the subsequent alkali treatment and wet disintegrating step.

The acid treatment is not particularly limited, and may be carried out by adding an acidic liquid to a dispersion containing the silica powder (including the dispersion in the form of a slurry; the same applies hereinafter) so that the pH in the system becomes at most 2, optionally with stirring. The acid treatment is preferably carried out at room temperature for at least 8 hours so as to be sufficiently conducted, though it is not particularly limited.

As the acidic liquid, an aqueous solution of sulfuric acid, hydrochloric acid, nitric acid or the like may be used. The concentration may be adjusted to from 1 to 37 mass %.

The silica concentration of the silica dispersion is preferably from 5 to 15 mass %. Further, the pH of the silica dispersion is preferably from 10 to 12.

The blend ratio of the silica dispersion and the acidic liquid is not particularly limited so long as the pH becomes at most 2.

The silica dispersion is preferably washed after the acid treatment, whereby a product formed by neutralization of the alkali metal salt included in the hydrothermal treatment by the acid treatment, can be removed.

The washing method is not particularly limited, and it is preferred to carry out washing with water by means of filtration or centrifugal washing.

The silica dispersion after washing may be mixed with water or concentrated to adjust the solid content. Further, in a case where the silica dispersion is recovered as a silica cake e.g. by filtration, water may be added to obtain a dispersion. The pH of the silica dispersion after washing is preferably from 4 to 6.

### [Aluminate Treatment]

The silica powder after the acid treatment may optionally be subjected to aluminate treatment. By the aluminate treatment, aluminum (Al) can be introduced to the surface of the silica particles in the silica powder to modify the surface to be negatively charged. The negatively charged silica powder has increased dispersibility in an acidic medium.

The aluminate treatment is not particularly limited, and may be carried out in such a manner that an aqueous solution of an aluminate is added to the dispersion containing the silica powder, followed by stirring as the case requires for mixing, and then the mixture is subjected to heat treatment to introduce Al to the surface of the silica particles. Mixing is preferably carried out at a temperature of from 10 to 30° C. for from 0.5 to 2 hours. Heating is preferably carried out under reflux, and is preferably carried out at a temperature of from 80 to 110° C. for at least 4 hours.

The aluminate may, for example, be sodium aluminate, potassium aluminate or the like or a combination thereof. Preferred is sodium aluminate, and the molar ratio of Al₂O₃ to SiO₂ is preferably adjusted to from 0.00040 to 0.00160.

The aqueous aluminate solution is preferably prepared to have a concentration of from 1 to 3 mass %. The aqueous aluminate solution can be added in an amount of from 5.8 to 80.0 parts by mass per 100 parts by mass of SiO₂ in the silica dispersion.

The silica concentration of the silica dispersion is preferably from 5 to 20 mass %. Further, the pH of the silica dispersion is preferably from 6 to 8.

The silica dispersion after the aluminate treatment may be mixed with water or concentrated to adjust the solid content. Further, the pH of the silica dispersion after the aluminate treatment is preferably from 6 to 8.

### [Alkali Treatment]

The process according to this embodiment comprises a step of subjecting the silica powder subjected to the acid treatment to alkali treatment at a pH of at least 8 to deflocculate the silica agglomerates. In a case where the aluminate treatment is carried out, the silica powder after the aluminate treatment is used. By the alkali treatment, it is possible to deflocculate the firm bonding of the silica agglomerates to disintegrate the silica agglomerates nearly into the respective scaly silica particles.

Here, deflocculation of the silica agglomerates means to apply a charge to the silica agglomerates to disperse the respective silica particles into a medium. By the alkali treatment, substantially all the silica particles contained in the silica powder may be deflocculated into the respective scaly silica particles, or only part of the silica particles may be deflocculated and the agglomerates may remain. Further, the entire part of the silica agglomerates contained in the silica dispersion may be deflocculated into the respective scaly silica particles, or only a part of the silica agglomerates may be deflocculated, and the agglomerate moieties may remain. The remaining agglomerates may be disintegrated into the respective scaly silica particles in the subsequent wet disintegrating step.

The pH at the time of the alkali treatment is at least 8, preferably at least 8.5, more preferably at least 9, whereby deflocculation of the silica agglomerates contained in the silica powder can be promoted. Further, even if the silica agglomerates remain after the alkali treatment, the bond of the silica particles of the silica agglomerates can be weakened, whereby the silica agglomerates are likely to be disintegrated into the respective silica particles in the subsequent wet disintegrating step.

The alkali treatment is not particularly limited and may be carried out in such a manner that an alkaline liquid is added to the dispersion containing the silica powder so that the pH became at least 8, followed by stirring as the case requires. Instead of the alkaline liquid, an alkali metal salt and water may separately be added. The alkali treatment is preferably carried out for from 1 to 48 hours, preferably from 2 to 24 hours, at a temperature of from 10 to 50° C.

The alkali metal salt may be a hydroxide, a carbonate or the like of an alkali metal such as lithium (Li), sodium (Na) or potassium (K), or a combination thereof. As the alkaline liquid, an aqueous solution containing such an alkali metal salt may be used. Further, as the alkaline liquid, aqueous ammonia (NH₄OH) may be used. The concentration of the alkali metal salt ((mass of alkali metal salt)/(total mass of moisture and alkali metal salt in silica dispersion)) may be adjusted to from 0.01 to 28 mass %, preferably from 0.04 to 5 mass %, more preferably from 0.1 to 2.5 mass %, in a state where the alkali metal salt is added to the dispersion containing the silica. Further, the alkali metal salt is from 0.4 to 2.5 mmol, preferably from 0.5 to 2 mmol per 1 g of the silica in the silica dispersion.

The silica concentration of the silica dispersion is preferably from 3 to 7 mass %. Further, the pH of the silica dispersion is preferably from 8 to 11.

The blend ratio of the silica dispersion and the alkaline liquid is not particularly limited so long as the pH becomes at least 8.

The average particle size of the silica powder contained in the silica dispersion after the alkali treatment is preferably from 3 to 10 μm, more preferably from 4 to 8.5 μm.

The silica dispersion after the alkali treatment may be mixed with water or concentrated to adjust the solid content. Further, the pH of the silica dispersion after the alkali treatment is preferably from 8.0 to 12.5.

### [Wet Disintegration]

The process according to this embodiment comprises a step of wet disintegrating the silica powder subjected to the alkali treatment to obtain scaly silica particles. Here, in the silica powder subjected to the alkali treatment, silica agglomerates partly remaining after the silica agglomerates are deflocculated and in addition, silica particles in a state where the silica agglomerates are formed into smaller particles to a certain extent, are contained. By wet disintegrating such a silica powder, the silica particles can further be disintegrated to obtain the respective scaly silica particles. By preliminary alkali treatment, deflocculation of the silica particles in the wet disintegration can be promoted. Thus, it is possible to prevent the silica particles from being not sufficiently disintegrated and remaining as irregular particles.

For the wet disintegration, a wet system pulverizing apparatus (disintegrator) which mechanically stirs grinding material at high speed using a pulverization medium, such as a wet bead mill, a wet ball mill, a thin-film spin system high-speed mixer or an impact grinder (such as a nanomizer) may be used. Particularly, it is preferred to use a wet bead mill and medium beads of alumina, zirconia or the like having a diameter of from 0.2 to 1 mm, whereby the silica powder can be disintegrated and dispersed while the basic laminated structure of the scaly silica particles are not pulverized or broken as far as possible. Further, by the impact grinder, the particles can be disintegrated into further smaller particles, by introducing a dispersion containing the powder into a thin tube of from 80 to 1,000 μm with a pressure applied thereto, to let the particles in the dispersion collide with one another and be dispersed.

The silica powder to be wet disintegrated is preferably supplied to the wet pulverizing apparatus after being diluted with e.g. purified water such as deionized water or distilled water into a dispersion having an appropriate concentration. The dispersion concentration is preferably from 0.1 to 20 mass %, and considering the disintegration efficiency and the working efficiency by the viscosity increase, more preferably from 0.1 to 15 mass %.

### [Cation Exchange Treatment]

The silica powder after the wet disintegration may optionally be subjected to cation exchange treatment, whereby the cation particularly metal ions contained in the silica powder can be removed.

The cation exchange treatment is not particularly limited and may be carried out in such a manner that a cation exchange resin is added to the silica dispersion containing the silica powder, followed by stirring as the case requires. The cation exchange treatment is preferably carried out at a temperature of from 10 to 50° C. for from 0.5 to 24 hours.

The resin matrix of the cation exchange resin may, for example, be a styrene type such as styrene/divinylbenzene or a (meth)acrylic acid type. Further, the cation exchange resin is preferably a hydrogen type (H-type) cation exchange resin, and may, for example, be a cation exchange resin having sulfonic acid groups, carboxy groups, phosphoric acid groups or the like. The cation exchange resin may be added in an amount of from 3 to 20 parts by mass per 100 parts by mass of SiO₂ in the silica dispersion.

The silica concentration of the silica dispersion is preferably from 3 to 20 mass %. Further, the pH of the silica dispersion is preferably at most 4.

### [Scaly Silica Particles]

By the above production process, scaly silica particles can be obtained. The scaly silica particles are composed of flaky silica primary particles, scaly silica secondary particles each formed by a parallel face-to-face alignment of a plurality of flaky silica primary particles which are overlaid one on another, or a combination thereof. By observation of the silica powder with a TEM, the shape of the scaly silica particles can be confirmed.

The average particle size of the silica powder containing the obtained silica scaly silica particles is preferably from 0.01 to 5 μm, more preferably from 0.05 to 4 μm, further preferably from 0.1 to 2 μm. In the above-produced silica powder, the amount of irregular particles with large particle sizes can be reduced, and accordingly the average particle size of the particles can be made to be at most 0.4 μm, particularly at most 0.3 μm.

The thickness of the scaly silica secondary particles is preferably from 0.001 to 3 μm, more preferably from 0.005 to 2 μm. The ratio (aspect ratio) of the maximum length relative to the thickness of the silica secondary particles is at least 10, preferably at least 30, more preferably at least 50. The ratio of the minimum length relative to the thickness of the silica secondary particles is at least 2, preferably at least 5, more preferably at least 10. The silica secondary particles are preferably present mutually independently without being fused.

Further, the average thickness of the flaky silica primary particles is preferably from 0.001 to 0.1 μm. Such silica primary particles can form scaly silica secondary particles each formed by a parallel face-to-face alignment of one or a plurality of silica primary particles which are overlaid one on another.

By the production process according to this embodiment, it is possible to obtain scaly silica particles in which formation of irregular particles is prevented. The irregular particles are particles in such a state that the silica agglomerates are formed into smaller particles to a certain extent but not formed into the respective scaly silica particles, and in a state where a plurality of scaly silica particles form an agglomerate. Of course, in the obtained scaly silica particles, inclusion of the silica agglomerates can be prevented.

Each of the irregular particles and the silica agglomerates can be confirmed as black particles or agglomerates by observation with a TEM. On the other hand, the scaly or flaky silica secondary particles or primary particles are observed as transparent or translucent by observation with a TEM.

Further, the silica purity of the scaly silica particles according to this embodiment is at least 95.0 mass %, preferably at least 99.0 mass %.

### [Scaly Silica Particles]

The scaly silica particles according to this embodiment are characterized by containing the scaly silica particles produced by the above production process. The scaly silica particles may be in the form of a powder or a dispersion having the powder dispersed in a medium. As the silica dispersion containing the scaly silica particles, the dispersion after the wet disintegration and the cation exchange treatment as the case requires, may be used as it is, or may be used after concentrated or diluted. Further, moisture in the silica dispersion may be removed and an organic solvent is added. The organic solvent may, for example, be benzene, toluene, xylene, coal oil or gas oil. The silica concentration in the silica dispersion is preferably from 1 to 80 mass %.

### [Hardenable Composition]

The scaly silica particles produced by the above production process may be used as a component in a hardenable composition. The scaly silica particles may be in the form of a powder or a dispersion, in the same manner as the above scaly silica particles. Further, the silica concentration of the hardenable composition is preferably from 1 to 80 mass %.

The hardenable composition may further contain a resin having a coating film-forming property, in addition to the scaly silica particles, and the resin is preferably an aqueous emulsion. The resin may be an acrylic resin, an epoxy resin, a urethane resin, a styrene resin, a silicone resin, a fluororesin, a vinyl acetate resin, a vinyl chloride resin, a polyester resin, a copolymer thereof, or a combination thereof.

The hardenable composition can form a cured product such as a coating film when applied to a substrate of e.g. a metal, glass, a ceramic or a plastic.

Further, the hardenable composition is useful for various applications, such as a particle binder, a coating material or agent for exterior or interior of buildings or structures, a coating material or agent having a thermal function (such as heat resistance, heat insulation, fireproofing, or flame retardancy), a coating material or agent having an optical function (such as ultraviolet ray-shielding, selective absorption of light, or light emission/fluorescence), a coating material or agent having an electrical/magnetical function (such as electrical insulation, electrical conductivity, antistatic function, wave-absorbing or electromagnetic wave-shielding), a coating material or agent having an adsorbing function (such as adsorption and desorption of moisture, adsorption and desorption of gas, or thin layer chromatography), a particle binder for adsorbent particles, a coating material or agent having a catalytic function (such as a photocatalyst), a particle binder for catalyst particles, a coating material or agent having a biological function (such as antibacterial, antiseptic, ship bottom anti-fouling, aquaculture or cell culture) and a coating material or agent having a fragrance or deodorant function.

### EXAMPLES

Now, the present invention will be described in further detail with reference to Examples. However, the present invention is by no means restricted thereto. As the unit of the solid content, “mass %” will be referred to simply as “%”.

### Example 1

### Preparation of Silica Dispersion

A silica hydrogel as the starting material was prepared as follows by using sodium silicate as the alkali source. 2000 ml/min of an aqueous sodium silicate solution having a SiO₂ concentration of 21.0 mass % with SiO₂/Na₂O=3.0 (molar ratio) and an aqueous sulfuric acid solution having a sulfuric acid concentration of 20.0 mass %, were introduced from separate inlets into a container equipped with a nozzle and instantaneously uniformly mixed. The ratio of the flow rates of the two solutions was so adjusted that the pH of the effluent ejected from the nozzle into air would be from 7.5 to 8.0, and the uniformly mixed silica sol liquid was continuously ejected into the air from the nozzle. The effluent were formed into spherical droplets in the air and turned into a gel in about a second while they fell down in the air parabolically. The falling droplets were let to dive into an aging tank containing water placed at their landing site and were aged.

The aging was followed by a pH adjustment to 6 and sufficient washing with water to give a silica hydrogel. The silica hydrogel particles were spherical in shape and had an average particle size of 6 mm. The mass ratio of water to SiO₂ in the silica hydrogel particles was 4.55.

The silica hydrogel particles were roughly pulverized with a double roll crusher to an average particle size of 2.5 mm and subjected to the subsequent hydrothermal treatment.

Into an autoclave (equipped with anchor type mixing blades) having a capacity of 17 m³, 6,201 kg of the silica hydrogel (SiO₂: 18 mass %) having a particle size of 2.5 mm and 1,400 kg of an aqueous sodium silicate solution (SiO₂: 28.72 mass %, Na₂O: 9.33 mass %, SiO₂/Na₂O: 3.18 (molar ratio)) were charged so that the total SiO₂/Na₂O molar ratio of the system would be 12.0. Then, 1,500 kg of water was added thereto, and 3,381 kg of high pressure water vapor with a saturation pressure of 17 kgf/cm² was added with stirring at 10 rpm, the temperature was increased to 185° C., and then the hydrothermal treatment was carried out for 5 hours. The total silica concentration in the system was 12.5 mass % in terms of SiO₂.

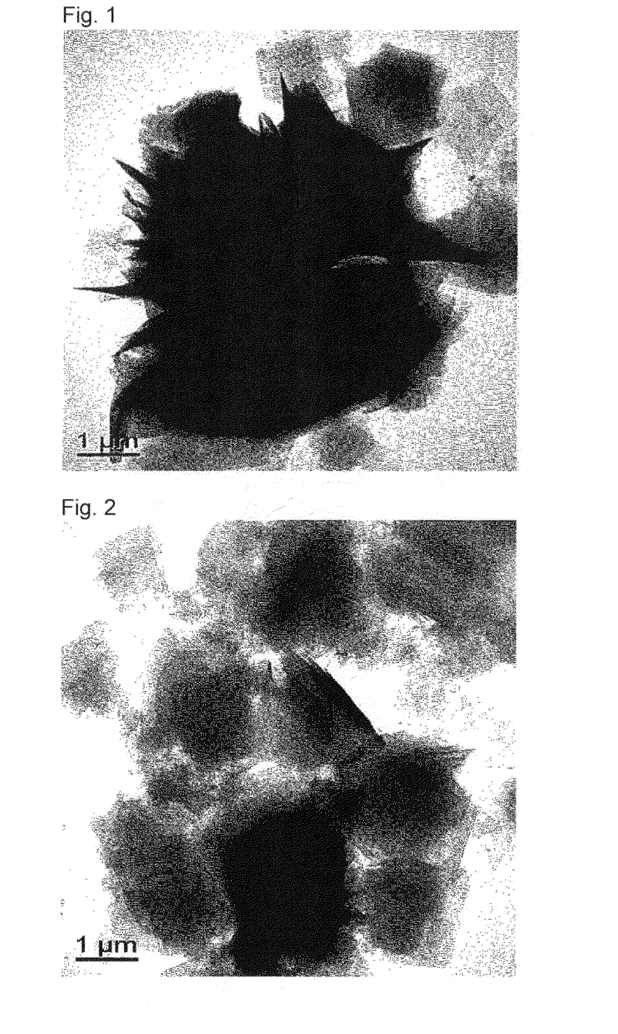

The prepared silica dispersion was filtrated and washed, and the silica powder was taken out and observed with a transmission electron microscope (TEM), and the results are shown in FIG. 1. As shown in FIG. 1, it was observed that silica agglomerates were contained in the silica dispersion. The average particle size of the silica particles as measured by a laser diffraction/scattering type particle size distribution measuring apparatus (“LA-950” manufactured by HORIBA, Ltd., the same applies hereinafter) was 8.71 μm.

### [Acid Treatment]

736 g of an aqueous sulfuric acid solution having a sulfuric acid concentration of 20.0 mass % was added to 6,500 g of the prepared silica dispersion (solid content: 14.1%, pH: 11.0) with stirring by a stirrer. The pH after addition was 1.9. Stirring was continued at room temperature for 24 hours to carry out treatment.

### [Washing]

The silica dispersion subjected to the acid treatment was washed by filtration with 50 ml of water per 1 g of the silica. The silica cake after washing was recovered, water was added thereto to prepare a slurry. The solid content of the silica dispersion as measured by an infrared moisture meter (“FD-60” manufactured by Kett Electric Laboratory, the same applies hereinafter) was 15.4%, and the pH was 5.1.

### [Alkali Treatment]

21.6 g (1 mmol/g silica) of potassium hydroxide and 5,200 g of water were added to 2,500 g of the silica dispersion after washing with stirring by a stirrer. The pH after addition was 9.4. Stirring was continued at room temperature for 23 hours to carry out treatment.

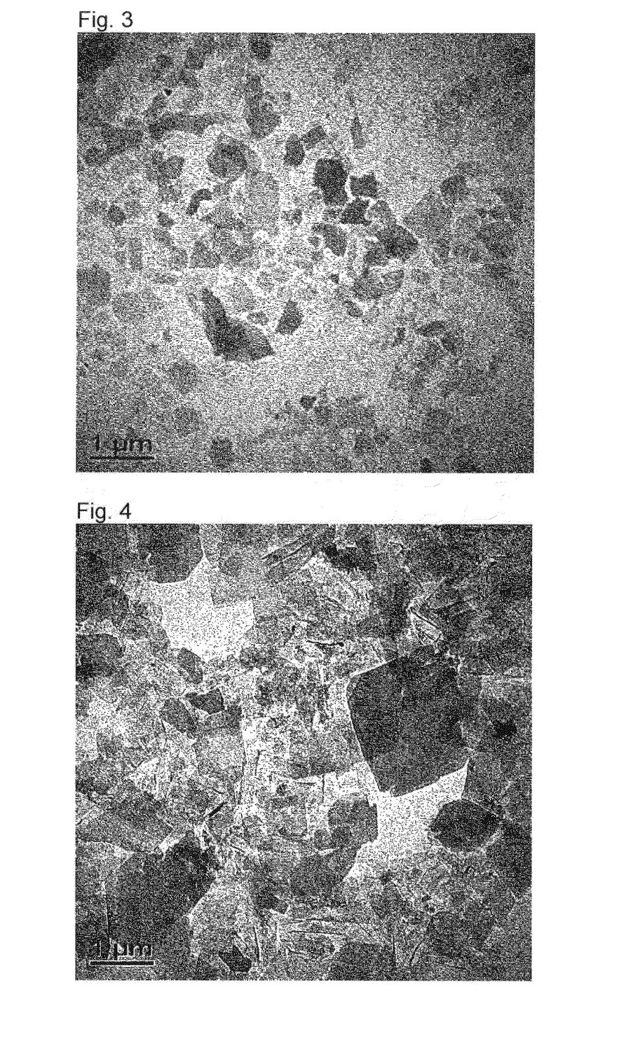

The silica powder was taken out from the silica dispersion after the alkali treatment and observed with a transmission electron microscope (TEM), and the results are shown in FIG. 2. As shown in FIG. 2, it was observed that silica particles having silica agglomerates deflocculated were contained in the silica dispersion. Further, the average particle size of the silica particles after the alkali treatment was 7.71 μm.

### [Wet Disintegration]

The silica dispersion after the alkali treatment was treated using a ultrahigh-pressure wet pulverization machine (“Nanomizer NM2-2000AR” manufactured by YOSHIDA KIKAI CO., LTD., collision-type generator with a pore size of 120 μm) under a discharge pressure of 140 MPa for 32 passes to disintegrate and disperse the silica particles. The pH of the silica dispersion after disintegration was 9.0, and the average particle size of the silica particles was 0.169 μm.

The silica powder was taken out from the silica dispersion after wet disintegration and observed with a transmission electron microscope (TEM), and the results are shown in FIG. 3. As shown in FIG. 3, it was observed that scaly silica particles were contained in the silica dispersion.

### [Cation Exchange]

2,583 ml of a cation exchange resin (“DIAION SK1B” manufactured by Mitsubishi Chemical Corporation, the same applies hereinafter) was added to 12,914 g of the silica dispersion after wet disintegration, followed by treatment at room temperature for 24 hours with stirring by an overhead stirrer. Then, the cation exchange resin was separated. The pH of the silica dispersion after cation exchange was 3.9.

### [Evaluation]

As shown in transmission electron micrographs in FIGS. 1 to 3, the silica agglomerates contained in the silica dispersion were disintegrated to scaly silica particles by means of the acid treatment, the alkali treatment and wet disintegration.

Further, the average particle size of the silica particles contained in the obtained silica dispersion was 0.169 μm, which was the same as that after wet disintegration. Further, the solid content of the obtained silica dispersion as measured by the infrared moisture meter was 2.7%.

### Example 2

A silica dispersion was prepared, and acid treatment and washing were carried out in the same manner as in Example 1.

### [Alkali Treatment]

3.4 g (1 mmol/g-silica) of potassium hydroxide and 810.4 g of water were added to 389.6 g of the silica dispersion after washing with stirring by a stirrer. The pH after addition was 9.4. Stirring was continued at room temperature for 19.5 hours to carry out treatment. Further, the average particle size of the silica particles after the alkali treatment was 7.82 μm.

### [Wet Disintegration]

The silica dispersion after the alkali treatment was treated by recycle treatment using a wet medium stirring mill (“ULTRA APEX MILL UAM-015” manufactured by KOTOBUKI INDUSTRIES CO., LTD., vessel capacity: 170 ml, packed with 80% of zirconia beads with a diameter of 0.05 mm) at a disk circumferential speed of 6 m/sec for a retention time of 60 minutes to disintegrate and disperse the silica particles. The pH of the silica dispersion after disintegration was 9.0, and the average particle size as measured by the laser diffraction/scattering type particle size distribution measuring apparatus was 0.194 μm.

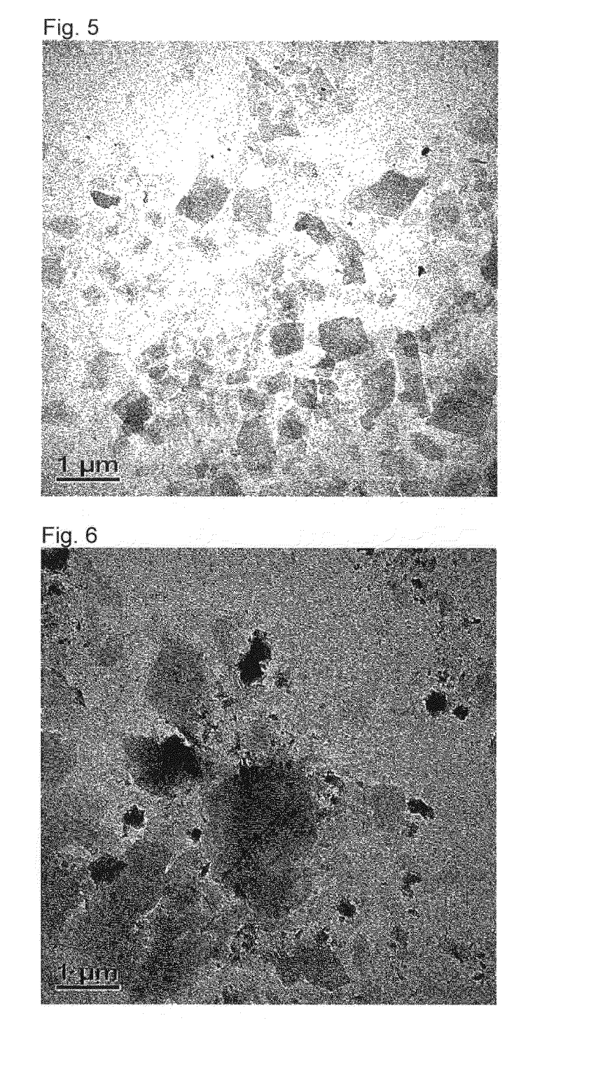

The silica powder was taken out from the silica dispersion after wet disintegration and observed by a transmission electron microscope (TEM), and the results are shown in FIG. 4. As shown in FIG. 4, it was observed that scaly silica particles were contained in the silica dispersion.

### [Cation Exchange]

16 ml of the cation exchange resin was added to 180 g of the silica dispersion after disintegration, followed by treatment at room temperature for 16.5 hours with stirring by an overhead stirrer. Then, the cation exchange resin was separated. The pH of the silica dispersion after cation exchange was 3.8.

### [Evaluation]

Silica particles were taken out from the obtained silica dispersion and their shape were observed by a TEM, whereupon it was observed that most of the particles were scaly particles, although a slight amount of irregular particles were contained.

Further, the average particle size of the silica particles contained in the obtained silica dispersion was 0.194 μm, which was the same as that after wet disintegration.

Further, the solid content of the obtained silica dispersion as measured by the infrared moisture meter was 4.3%.

### Example 3

### Preparation of Silica Dispersion

A silica hydrogel was prepared in the same manner as in Example 1.

The silica hydrogel particles were roughly pulverized to an average particle size of 2.5 mm by a double roll crusher and subjected to the subsequent hydrothermal treatment.

Into an autoclave (equipped with anchor type mixing blades) having a capacity of 17 m³, 7,249 kg of the above silica hydrogel (SiO₂: 18 mass %) having a particle size of 2.5 mm and 1,500 kg of an aqueous sodium silicate solution (SiO₂: 29.00 mass %, Na₂O: 9.42 mass %, SiO₂/Na₂O=3.18 (molar ratio)) were charged so that the total SiO₂/Na₂O molar ratio of the system would be 12.0. Then, 1,560 kg of water was added thereto, and 4,682 kg of a high pressure water vapor with a saturation pressure of 17 kgf/cm² was added thereto with stirring at 10 rpm, the temperature was increased to 185° C., and then hydrothermal treatment was carried out for 5 hours. The total silica concentration in the system was 12.5 mass % in terms of SiO₂.

The prepared silica dispersion was filtrated and washed, and the silica powder was taken out. The average particle size of the silica particles was 8.33 μm.

### [Acid Treatment]

1,083 g of an aqueous sulfuric acid solution having a sulfuric acid concentration of 20 mass % was added to 10,100 g of the prepared silica dispersion (solid content: 13.3%, pH: 11.4) with stirring by a stirrer. The pH after addition was 1.5. Stirring was continued at room temperature for 18 hours to carry out treatment.

### [Washing]

The silica dispersion after the acid treatment was washed by filtration with 50 ml of water per 1 g of the silica. The silica cake after washing was recovered, and water was added thereto to prepare a slurry. The solid content of the silica dispersion as measured by the infrared moisture meter was 14.7%, and the pH was 4.8.

### [Aluminate Treatment]

7,000 g of the silica dispersion after washing was put into a 10 L flask, and 197 g (Al₂O₃/SiO₂ molar ratio=0.00087) of an aqueous sodium aluminate solution having a concentration of 2.02 mass % was added little by little with stirring by an overhead stirrer. The pH after addition was 7.2. After addition, stirring was continued at room temperature for one hour. Then, the temperature was increased, and treatment was carried out under reflux with heating for 4 hours.

### [Alkali Treatment]

43.5 g (1 mmol/g silica) of potassium hydroxide and 1,381 g of water were added to 775 g of the silica dispersion after the aluminate treatment with stirring by a stirrer. The pH after addition was 9.9. Stirring was continued at room temperature for 24 hours to carry out treatment. The average particle size of the silica particles after the alkali treatment was 7.98 μm.

### [Wet Disintegration]

The silica dispersion after the alkali treatment was treated using an ultrahigh-pressure wet pulverization machine (“Nanomizer NM2-2000AR” manufactured by YOSHIDA KIKAI CO., LTD., collision-type generator with a pore size of 120 μm) under a discharge pressure of from 130 to 140 MPa for 30 passes to disintegrate and disperse the silica particles. The pH of the silica dispersion after disintegration was 9.3, and the average particle size as measured by the laser diffraction/scattering type particle size distribution measuring apparatus was 0.182 μm.

The silica powder was taken out from the silica dispersion after wet disintegration and observed by a transmission electron microscope (TEM), and the results are shown in FIG. 5. As shown in FIG. 5, it was observed that scaly silica particles were contained in the silica dispersion.

### [Cation Exchange]

161 ml of a cation exchange resin was added to 1,550 g of the silica dispersion after disintegration, followed by treatment at room temperature for 17 hours with stirring by an overhead stirrer. Then, the cation exchange resin was separated. The pH of the silica dispersion after cation exchange was 3.7.

### [Evaluation]

The silica particles were taken out from the obtained silica dispersion and their shape was observed by a TEM, whereupon it was confirmed that the silica particles consisted solely of scaly silica particles containing substantially no irregular particles.

Further, the average particle size of the silica particles contained in the obtained silica dispersion was 0.182 μm which was the same as that after wet disintegration.

Further, the solid content of the obtained silica dispersion as measured by the infrared moisture meter was 3.6%.

### Comparative Example 1

### Preparation of Silica Dispersion

A silica hydrogel was prepared in the same manner as in Example 1.

The silica hydrogel particles were roughly pulverized to an average particle size of 2.5 mm by a double roll crusher and subjected to the subsequent hydrothermal treatment.

Into an autoclave (equipped with anchor type mixing blades) having a capacity of 17 m³, 7,600 kg of the silica hydrogel (SiO₂: 18 mass %) having a particle size of 2.5 mm and 1,800 kg of an aqueous sodium silica solution (SiO₂: 28.63 mass %, Na₂O: 9.34 mass %, SiO₂/Na₂O=3.16 (molar ratio)) were charged so that the total SiO₂/Na₂O molar ratio in the system would be 12.0. Then, 4,669 kg of water was added, and 3,381 kg of high pressure water vapor with a saturation pressure of 17 kgf/cm² was added with stirring at 10 rpm, the temperature was increased to 185° C., and hydrothermal treatment was carried out for 6 hours. The total silica concentration in the system was 12.5 mass % in terms of SiO₂.

The prepared silica dispersion was filtrated and washed, and the silica powder was taken out. The average particle size of the silica particles was 8.01 μm.

### [Acid Treatment]

The prepared silica dispersion (solid content: 13.1%, pH: 11.5) was continuously added into a 60 L tank made of an acrylic resin at a flow rate of 2.0 to 2.5 L/min, and an aqueous sulfuric acid solution having a sulfuric acid concentration of 20.0 mass % was continuously added with stirring by an overhead stirrer to maintain the pH of the silica dispersion in the tank to be 3.5. Stirring was continued at room temperature for about 40 minutes to carry out treatment.

### [Washing]

The silica dispersion after the acid treatment was supplied to a horizontal belt filter (“502 model TSUKISHIMA horizontal belt filter” manufactured by TSUKISHIMA KIKAI CO., LTD.) at a flow rate of from 2.0 to 2.5 L/min, and washed by filtration with 10 ml of water per 1 g of the silica. The silica cake after washing was recovered, and water was added thereto to prepare a slurry. The solid content of the silica dispersion as measured by the infrared moisture meter was 13.3%, and the pH was 6.1.

### [Wet Disintegration]

The silica dispersion after washing was treated using a wet medium stirring mill (“DYNO MILL KD-25C” manufactured by SHINMARU ENTERPRISES CORPORATION, vessel capacity: 25 L, packed with 80% of zirconia beads having a diameter of 0.5 mm) at a disk circumferential speed of 16 m/sec at a flow rate of 60 L/h for one pass to disintegrate and disperse the silica particles. The average particle size of the silica dispersion after disintegration as measured by the laser diffraction/scattering type particle size distribution measuring apparatus was 0.426 μm.

The silica powder was taken out from the silica dispersion after wet disintegration and observed by a transmission electron microscope (TEM), and the results are shown in FIG. 6. As shown in FIG. 6, it was observed that a large amount of irregular particles which were observed as black were contained in the silica dispersion.

### [Evaluation]

The silica particles were taken out from the obtained silica dispersion and their shape was observed by a TEM, whereupon it was confirmed that the particles were scaly particles with a large amount of irregular particles.

Further, the average particle size of the silica particles contained in the obtained silica dispersion was 0.426 μm, which was the same as that after wet disintegration.

Further, the solid content of the obtained silica dispersion as measured by the infrared moisture meter was 13.5%.

The production conditions and the evaluation results in the above Examples and Comparative Example are summarized in Table 1.

In Table 1, presence of irregular particles was evaluated based on the following standards by observation of the silica particles contained in the silica dispersion by a TEM. Here, the irregular particles are particles observed as black in a transmission electron micrograph (FIG. 6), and scaly particles are particles observed as transparent or translucent (FIGS. 3 to 5).

A: No irregular particles were confirmed in the silica particles, and only scaly particles were observed.

B: A slight amount of irregular particles were confirmed in the silica particles, but more than half of the silica particles in number were scaly particles.

C: Silica particles were scaly particles in which irregular particles were present with a proportion more than half the silica particles in number.

TABLE 1
Process conditions and evaluation results in Examples and Comparative Example

| | | Ex. 1 | Ex. 2 | Ex. 3 | Comp. Ex. 1 |
|---|---|---|---|---|---|
| Process | pH at acid | 1.9 | 1.9 | 1.5 | 3.5 |
| conditions | treatment | | | | |
| | Aluminate | Nil | Nil | Conducted | Nil |
| | treatment | | | | |
| | pH at alkali | 9.38 | 9.42 | 9.9 | Nil |
| | treatment | | | | |
| | Wet | Ultrahigh- | Wet medium | Ultrahigh- | Wet medium |
| | disintegration | pressure wet | stirring mill | pressure wet | stirring mill |
| | | pulverization | | pulverization | |
| | | apparatus | | apparatus | |
| Evaluation | Presence of | A | B | A | C |
| | irregular | | | | |
| | particles | | | | |
| | Average particle | 0.169 | 0.194 | 0.182 | 0.426 |
| | size (μm) of the | | | | |
| | obtained silica | | | | |
| | particles | | | | |

As evident from the transmission electron micrographs in FIGS. 3 to 5 and Table 1, each of the silica dispersions in Examples 1 to 3 contained substantially no irregular particles and consisted substantially of scaly silica particles.

The silica dispersion in Comparative Example 1 contained, in addition to scaly silica particles, irregular particles observed as black, as shown in the transmission electron micrograph in FIG. 6 and Table 1.

### [Measurement of Zeta Potential]

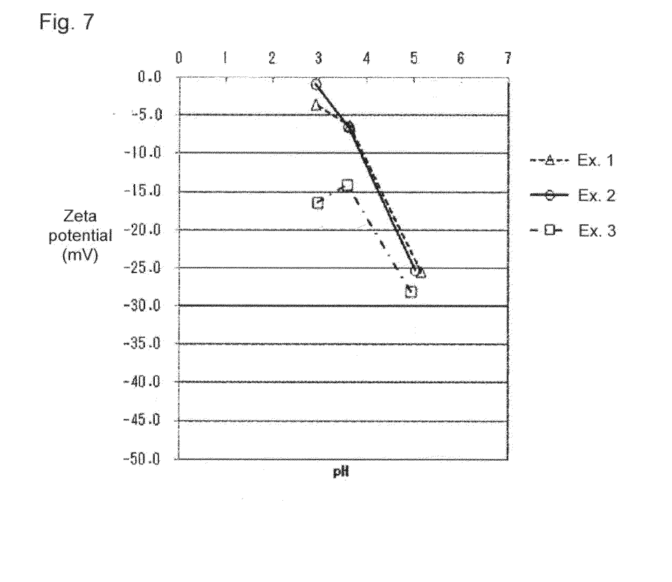

A 10 mM aqueous NaCl solution was added to and mixed with each of the silica dispersions after cation exchange obtained in Examples 1 to 3 so that the silica concentration would be 0.05%. A predetermined amount of an aqueous HCl or NaOH solution was added thereto to adjust the pH optionally to prepare a measurement sample. The zeta potential of such a sample was measured by a zeta potential meter (“Zetasizer nano ZS” manufactured by Malvern) with a sample number n=3, and the average was taken as the zeta potential of the silica dispersion. The results are shown in FIG. 7.

As shown in FIG. 7, in Example 3 in which the aluminate treatment was conducted, a high negative potential was observed particularly in an acidic region. Accordingly, it is found that the dispersion stability in an acidic liquid improve by carrying out the aluminate treatment.

The entire disclosure of Japanese Patent Application No. 2012-245991 filed on Nov. 8, 2012 including specification, claims, drawings and summary is incorporated herein by reference in its entirety.

What is claimed is:

1. A process for producing scaly silica particles, which comprises:
a step of subjecting a silica powder containing silica agglomerates having scaly silica particles agglomerated, to acid treatment at a pH of at most 2;
a step of subjecting the silica powder subjected to the acid treatment, to alkali treatment at a pH of at least 8 to deflocculate the silica agglomerates; and
a step of wet disintegrating the silica powder subjected to the alkali treatment to obtain scaly silica particles.

2. The process for producing scaly silica particles according to claim 1, wherein the main peak obtained by X-ray diffraction analysis of the silica powder containing silica agglomerates having scaly silica particles agglomerated, is a peak corresponding to silica X and/or silica Y.

3. The process for producing scaly silica particles according to claim 1, wherein the average particle size of the silica powder after the wet disintegration is from 0.01 μm to 5 μm.

4. The process for producing scaly silica particles according to claim 1, wherein the alkali treatment is to treat the silica powder with an aqueous solution of at least one of LiOH, KOH and NaOH.

5. The process for producing scaly silica particles according to claim 1, wherein the scaly silica particles are flaky silica primary particles and/or scaly silica secondary particles each formed by a parallel face-to-face alignment of a plurality of flaky silica primary particles which are overlaid one on another.

6. The process for producing scaly silica particles according to claim 1, wherein the process further has a step of subjecting at least one of a silica hydrogel, a silica sol and hydrous silicic acid to hydrothermal treatment in the presence of an alkali metal salt to form a silica powder containing agglomerates having scaly silica particles agglomerated, and the formed silica powder is used for the acid treatment step.

7. The process for producing scaly silica particles according to claim 1, wherein the process further has a step of treating the silica powder subjected to the acid treatment with an aluminate, and the silica powder treated with the aluminate is used for the alkali treatment step.

8. The process for producing scaly silica particles according to claim 1, wherein the process further has a step of subjecting the wet disintegrated silica powder to cation exchange treatment.

9. Scaly silica particles produced by the process for producing scaly silica particles as defined in claim 1.
